(19) United States
(12) Patent Application Publication
(10) Pub. No.: US 2013/0297445 A1
(43) Pub. Date: Nov. 7, 2013

(54) PROPOSED SPECIFICATION PREPARATION DEVICE AND PROPOSED SPECIFICATION PREPARATION METHOD

(71) Applicants: Shinichi Taniguchi, Yokohama (JP); Tomotoshi Ishida, Hitachinaka (JP); Takaharu Matsui, Hayama (JP); Noriyuki Haga, Yokohama (JP); Junichi Hamano, Yokosuka (JP)

(72) Inventors: Shinichi Taniguchi, Yokohama (JP); Tomotoshi Ishida, Hitachinaka (JP); Takaharu Matsui, Hayama (JP); Noriyuki Haga, Yokohama (JP); Junichi Hamano, Yokosuka (JP)

(73) Assignee: Hitachi, Ltd., Tokyo (JP)

(21) Appl. No.: 13/981,097

(22) PCT Filed: Dec. 16, 2011
(86) PCT No.: PCT/JP2011/079214

§ 371 Date: Jul. 23, 2013

(30) Foreign Application Priority Data
Feb. 23, 2011 (JP) 2011-036970

(51) Int. Cl. G06Q 30/06

(52) U.S. Cl. CPC G06Q 30/0621
USPC 705/26.5

(57) ABSTRACT

A case database which stores requirement specifications in the past, and product specifications; a proposal base selection unit which selects a proposed base that becomes the gist of a newly proposed requirement specification; a requirement specification draft preparation unit which compares a requirement specification included in the proposal base and the requirement specification included in the requirement specification original plan, and when the requirement specification included in the proposal base does not satisfy the requirement of a customer, corrects the requirement specification included in the proposal base to the requirement specification included in the requirement specification original plan or a requirement specification similar to the requirement specification included in the requirement specification original plan among the requirement specifications stored in the case database; and a product specification draft preparation unit which prepares a product specification in accordance with the requirement specification prepared by the requirement specification draft preparation unit.

### FIELD OF THE INVENTION

The present invention relates to a proposed specification preparation device and a proposed specification preparation method, for preparing a product specification draft in accordance with a requirement specification original draft of a customer and completing a requirement specification draft.

### BACKGROUND OF THE INVENTION

In the business of individually designed products, a customer prepares a requirement specification form to give out an order to the manufacturer. Then, the manufacturer designs and produces a particular product, based on the requirement specification form. However, in many cases, the customer does not have enough knowledge of the product, and the customer generally requests the manufacturer to make a proposal for product specifications, in order for the manufacturer to prepare the requirement specification form, before placing the order. This is to prevent unacceptable costs and due dates. If the manufacturer designs and produces the product simply in accordance with the customer-prepared requirement specification form, the product is designed individually as an “only one item”, thus realizing the product based on the requirement specifications.

Upon reception of a request for a proposal, the manufacturer prepares the product specification form while checking the possibility, cost, and due date of the product. The manufacturer also completes the requirement specification form, and changes/corrects excess requests of the customer as needed. The customer gives out an order for the product to the manufacturer using the completed requirement specification form. After accepting the order, the manufacturer designs and produces the product, based on the product specification draft which has been examined in advance. Through these processes, the customer can obtain the product in accordance with the specifications, cost, and due date, that are acknowledged before placing the order. To realize the customer requested functions with an appropriate cost and due date, it is required that the manufacturer eliminates the individual designing as much as possible and realize the product in accordance with the standard designs.

For example, Japanese Unexamined Patent Application Publication No. 2001-14021 discloses an order receiving system which calculates the customer satisfaction, when preparing recommended specification candidates in which requested parts are replaced with replacement parts, for a product including customer-specified constituent parts. In this order-receiving system, the customer satisfaction is calculated based on the distance between the customer requirement specifications and the recommended specification candidates, thus enabling to select the recommended specifications (in consideration of the customer request) and to present as an alternative draft.

Japanese Unexamined Patent Application Publication No. 2008-204390 discloses a standard specification selection device which classifies the product specifications into “standard” and “special”, reflecting the tendency of the customer requests that may change from one to another, and enables to select only the “standard” specification. In this standard specification selection device, points are assigned to the specification items based on the orders received. The product specifications are classified into “standard” and “special” using the assigned points. Further, the specification items (order determinants) are weighted to calculate the points, thus enabling to set the standard specification without divergence from the customer requests.

However, the order receiving system disclosed in Japanese Unexamined Patent Application Publication No. 2001-14021 has a problem that the system cannot be applied to some products whose connection relationship between the parts may change in accordance with the customer requests, based on the assumption that the customer indicates constituent parts. Further, the standard specification selection device disclosed in Japanese Unexamined Patent Application Publication No. 2008-204390 has a problem that it cannot correspond to the customer requests that do not correspond to the standard specification of the manufacturer.

### SUMMARY OF THE INVENTION

The present invention aims to solve the above problem. An object of the present invention is to provide a proposed specification preparation device and a proposed specification preparation method, which can be applied to a product whose connection relationship between its parts may change in accordance with customer requests, and which can present product specifications acceptable for the customer even when the customer requests do not correspond to the manufacturer standard specifications. That is, an object thereof is to provide a proposed specification preparation device and a proposed specification preparation method, for enabling to present product specifications which can be provided by the manufacturer accepting the customer requests.

To solve the above problem and to attain the objects, according to the present invention, there is provided a proposed specification preparation device including: an input unit which receives an input of a requirement specification original draft, including a requirement specification from a customer and requirement strength information representing whether the requirement specification is abandonable, in association with each other; a case database which stores requirement specifications proposed based on the requirement specification in the past and a product specification prepared in accordance with the proposed requirement specification; a proposal base selection unit which selects a proposal base as a main point of a requirement specification to be newly proposed, from the proposed requirement specifications stored in the case database, based on the requirement specification and the requirement strength included in the requirement specification original draft received by the input unit; a requirement specification draft preparation unit which compares the requirement specification included in the proposal base with the requirement specification included in the requirement specification original draft, and when the requirement specification included in the proposal base does not satisfy a requirement of the customer, changes the requirement specification included in the proposal base into the requirement specification included in the requirement specification original draft or the requirement specification similar to the requirement specification included in the requirement specification original draft within the requirement specifications stored in the case database; a product specification draft preparation unit which prepares the product specification in accordance with the requirement specification prepared by the requirement specification draft preparation unit; and an output unit which outputs a proposed specification form including the requirement specification draft and the product specification draft.

According to the present invention, there is provided a proposed specification preparation method executed by the proposed specification preparation device.

According to the present invention, there is provided a proposed specification preparation device and a proposed specification preparation method, for enabling to presenting product specifications providable by a manufacturer that accepts customer requirements.

### BRIEF DESCRIPTION OF THE DRAWINGS

FIG. 1 is a diagram showing a functional configuration of a proposed specification preparation device as an embodiment of the present invention;

FIG. 2 is a diagram showing a configuration of a project table, as an example of proposed case information stored in a case database according to the embodiment of the present invention;

FIG. 3 is a diagram showing a configuration of a requirement specification table, as an example of proposed case information stored in the case database according to the embodiment of the present invention;

FIG. 4 is a diagram showing a product specification table, as an example of proposed case information stored in the case database according to the embodiment of the present invention;

FIG. 5 is a diagram showing a configuration example of requirement similarity information stored in a similarity definition database, according to the embodiment of the present invention;

FIG. 6 is a diagram showing a configuration example of requirement specification original draft information including a requirement specification original draft and the requirement strength, input from an input unit according to the embodiment of the present invention;

FIG. 7 is a diagram showing a configuration example of proposal base information output by a proposal base selection unit according to the embodiment of the present invention;

FIG. 8A is a diagram showing a process flow for preparing a product specification draft and a requirement specification draft using a proposed specification preparation device according to the embodiment of the present invention;

FIG. 8B is a diagram showing a process flow of a similarity calculation process of Step S2 illustrated in FIG. 8A;

FIG. 9 is a diagram showing an example of a screen for inputting the requirement specification original draft and the requirement strength through the input unit according to the embodiment of the present invention;

FIG. 10 is a diagram showing an example of a screen displaying a similarity calculation result by the proposal base selection unit according to the embodiment of the present invention; and

FIG. 11 is a diagram showing an example of a screen outputting a requirement specification draft and a proposed specification draft by an output unit according to the embodiment of the present invention.

### DETAILED DESCRIPTION OF THE PREFERRED EMBODIMENT

A proposed specification preparation device and a proposed specification preparation method according to an embodiment of the present invention will now specifically be described with reference to the attached drawings. The same reference numerals are assigned to substantially the same parts, and the same parts will not repeatedly be explained.

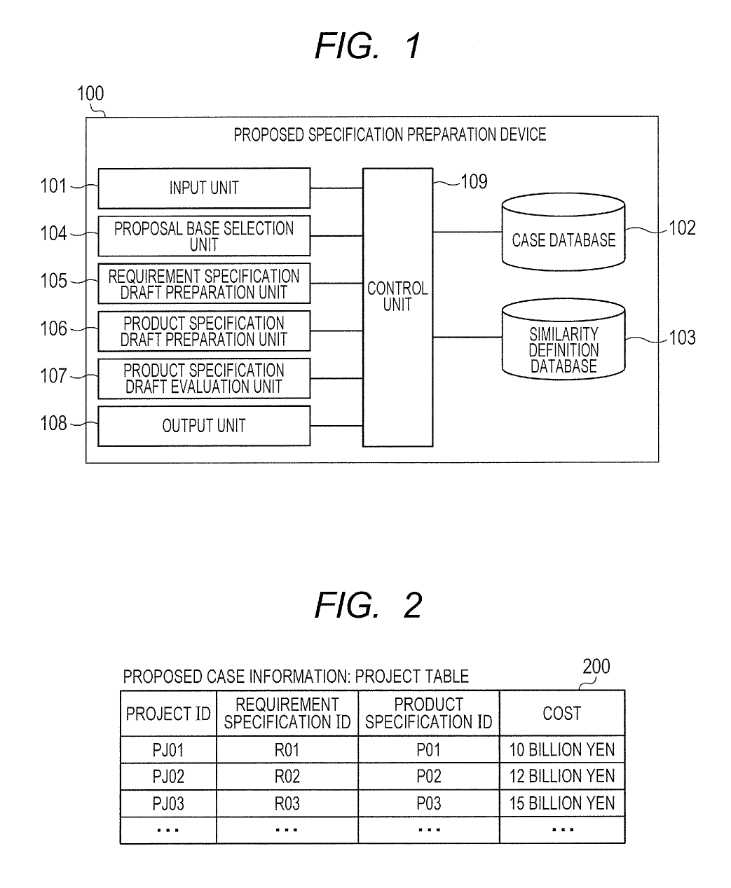

FIG. 1 is a diagram showing a functional configuration of a proposed specification preparation device 100 according to an embodiment of the present invention. As illustrated in FIG. 1, the proposed specification preparation device 100 in this embodiment includes an input unit 101, a case database 102, a similarity definition database 103, a proposal base selection unit 104, a requirement specification draft preparation unit 105, a product specification draft preparation unit 106, a product specification draft evaluation unit 107, an output unit 108, and a control unit 109.

The input unit 101 accepts a requirement specification original draft (representing the original draft of a product specification required from a customer), requirement strength information (representing the strength of requirement of a requirement specification item included in the requirement specification original draft), the specification about a newly designed part of a product, cost information, and a selection result of choices among product specification drafts presented by the proposed specification preparation device 100. The input unit 101 includes, for example, a keyboard, a mouse, a touch-panel input button displayed on a computer screen, a selection menu, etc.

The case database 102 is a database which stores proposed case information. The proposed case information includes requirement specifications prepared in the past, product specifications prepared in the past, and product cost information prepared in accordance with the product specifications, in association with each other. A specific example of the case database 102 will later be described using FIG. 2.

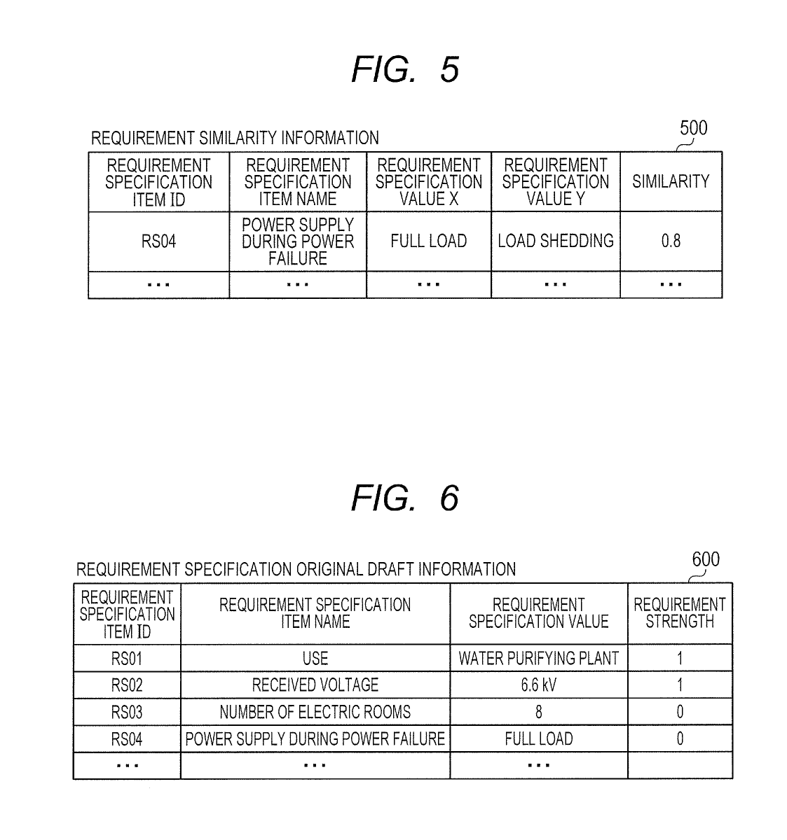

The similarity definition database 103 is a database which stores requirement similarity information defining the similarities between requirement specification values as values of requirement specification items included in the requirement specification original draft in the past. A specific example of the similarity definition database 103 will later be described using FIG. 5.

The proposal base selection unit 104 is to select a proposal base (will be described later) representing the main points of a newly designed part of a product. The proposal base selection unit 104 reads the requirement specification original draft input from the input unit 101 and the past requirement specifications included in the proposed case information stored in the case database 102, calculates the similarity between the requirement specification original draft and the requirement specifications of the proposed case information while referring to the requirement similarity information stored in the similarity definition database 103, and selects a proposal base.

The requirement specification draft preparation unit 105 is to correct/change a requirement specification original draft input from the input unit 101. The requirement specification draft preparation unit 105 refers to the similarity calculated by the proposal base selection unit 104, reads a requirement specification having a lower similarity value in association with a requirement specification original draft in the proposal base, than a predetermined value, searches for a case with the highest similarity to the requirement specification from the proposed case information stored in the case database 102, and replaces the requirement specification original draft with the contents of the case.

The product specification draft preparation unit 106 is to change the product specification that does not satisfy the requirement, in the proposal base. The product specification draft preparation unit 106 replaces the product specification in the proposal base with the product specification corresponding to the requirement specification item, when the requirement specification draft preparation unit 105 replaces a requirement specification original draft with the contents of a similar case.

The product specification draft evaluation unit 107 is to calculate the cost in the product specification draft. The product specification draft evaluation unit 107 reads cost information included in the proposed case information stored in the case database 102, and adds up the costs in the product specification draft prepared by the product specification draft preparation unit 106. Below, the product specification draft evaluation unit 107 adds up the costs in the product specification draft. Other than the costs, the unit 107 may perform evaluation by adding up at least one kind of information item from: functions; performance; cost; and due dates of a product (for example, a power generator as a product, in a case of a system which provides electricity).

The output unit 108 is to output the requirement specification draft, the product specification draft, and estimation form. The output unit 108 is configured to output the requirement specification draft prepared by the requirement specification draft preparation unit 105, the product specification draft prepared by the product specification draft preparation unit 106, and the cost information added up by the product specification evaluation unit 107, and to output a requirement specification form and a proposed specification form in a predetermined format. The output unit 108 is configured with a CRT, a liquid crystal display, a printer, and the like.

The control unit 109 is to control the input/output of each of the above-described units and the process flows as will be described below. The above-described proposal base selection unit 104, the requirement specification draft preparation unit 105, the product specification draft preparation unit 106, the product specification draft evaluation unit 107, and the control unit 109 are realized upon operation of a computer program. The proposed specification preparation device 100 is configured with a computer device, such as a PC, a server, or the like, and has a CPU (Control Processing Unit), a memory unit, an input unit, and an output unit. Various databases store information available by computers. Various processes are realized by loading programs (installed, for example, in the memory unit or ROM (Read Only Memory)) into RAM (Random Access Memory) and executing the programs.

FIG. 2 is a diagram showing a configuration of a project table as an example of proposal case information stored in the case database 102 according to the embodiment of the present invention. The proposal case information includes, as will be described later, a project table for identifying a target project for preparing a product, a requirement specification table representing specific contents of the requirement specifications, and a product specification table representing specific contents of the product specification.

As illustrated in FIG. 2, the project table 200 stores requirement specifications regarding the proposal case in the past, product specifications regarding the proposal case in the past, and the costs of the product specifications, in association with each other. In the example of FIG. 2, the project table 200 is configured to include project IDs, requirement specification IDs, product specification IDs, and costs, in association with each other. In this case, the project IDs, the requirement specification IDs, and the product specification IDs are data respectively identifying the projects, the requirement specifications, and the product specifications. The costs are data representing the cost of the product identified by the corresponding product specification ID.

For example, in FIG. 2, for a project identified by the project ID “PJ01” for preparing a particular product, the requirement specification with the requirement specification ID “R01” is given. In addition, it is obvious that the product is manufactured in accordance with the product specification with a product specification ID “P01”, and its cost is “ten billion yen”.

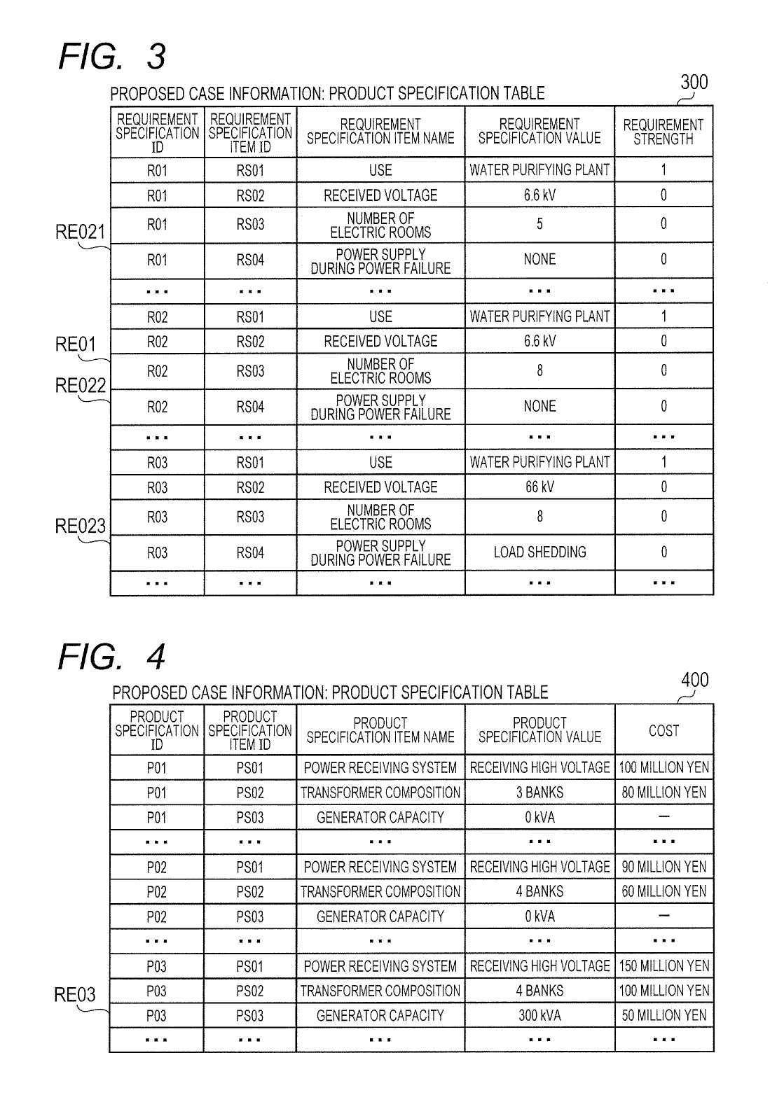

FIG. 3 is a diagram showing a configuration of a requirement specification table, as an example of proposal case information stored in the case database 102 according to the embodiment of the present invention. As illustrated in FIG. 3, the requirement specification table 300 stores requirement specification items of projects, names, values of the requirement specification items (requirement specification value), and the requirement strengths, in association with each other. In the example of FIG. 3, the requirement specification table 300 includes requirement specification IDs, requirement specification item IDs, requirement specification item names, requirement specification values, and requirement strengths, in association with each other. In this case, the requirement specification item ID is data for identifying the requirement specification item, and the requirement specification item name is the name of the requirement specification item. The requirement specification value is information or a value representing the specific contents of the requirement specification item. The requirement strength is data indicating an index representing the strength of the customer requirement. In this embodiment, the requirement which cannot be abandoned is “1” while the requirement which can be abandoned is “0”.

For example, in FIG. 3, the requirement specifications identified by a requirement specification ID “R01” includes requirement specification items “RS01” to “RS04”. The names of the respective requirement specification items include information of “use”, “received voltage”, “number of electric rooms”, and “power supply during power failure”. These values represent “water purifying plant”, “6.6 kV”, “5”, and “none”. Based on the requirement strength of each of the requirement specification items, the “use” cannot be abandoned. Other than this item, “received voltage”, “number of electric rooms”, “power supply during power failure” can be abandoned.

FIG. 4 is a diagram showing a configuration of a product specification table, as an example of proposed case information stored in the case database 102 according to the embodiment of the present invention. As illustrated in FIG. 4, the product specification table 400 stores the product specification items of projects, names, values of the product specification items (product specification item values), and costs, in association with each other. In the example of FIG. 4, the product specification IDs, the product specification item IDs, the product specification item names, the product specification values, and the costs are stored, in association with each other. The product specification item ID is data for identifying the product specification item, and the product specification item name is the name of the product specification item. The product specification value is a value corresponding to the product specification item, and the cost represents the cost for realizing the product specifications represented by the specification value.

For example, in FIG. 4, the product specifications identified by the production specification ID “P01” include the product specification items “PS01” to “PS03”. Names of the product specification items are “power receiving system”, “transformer composition”, “generator capacity”, and “power supply during power failure”. These values respectively represent “receiving high voltage”, “three banks”, and “0 kVA”. The costs in the product specification items are “one hundred million yen” when the power receiving system is “receiving high voltage”, and “eight million yen” when the transformer composition is “three banks”.

FIG. 5 is a diagram showing a configuration of requirement similarity information stored in the similarity definition database 103 according to the embodiment of the present invention. As illustrated in FIG. 5, requirement similarity information 500 includes two requirement specification values corresponding to each other, and is information defining the similarity between these requirement specification values. In the example of FIG. 5, the requirement similarity information 500 is composed of the requirement specification items ID, the requirement specification item names, the requirement specification values X, the requirement specification values Y, and the similarities, in association with each other. The requirement specification value X and the requirement specification value Y are two requirement specification values subject to defining the similarity. The similarity is data which quantitatively represents the degree of similarity between the requirement specification value X and the requirement specification value Y. In this embodiment, the similarity of when the two requirement specification values are equal is “1.0”, and the similarity of when the two values are not equal at all is “0.0”. In the example of FIG. 5, in “power supply during power failure”, the similarity is “0.8” between “full load” and “load shedding”.

FIG. 6 is a diagram showing a configuration example of requirement specification original draft information including the requirement specification draft input into the input unit 101 according to the embodiment of the present invention. As illustrated in FIG. 6, requirement specification original draft information 600 includes requirement specification item IDs, requirement specification item names, requirement specification values, and requirement strength information, in association with each other.

For example, in the example of FIG. 6, as the requirement specification item name “use” identified by the requirement specification item ID “RS01”, a requirement specification value corresponding to “water purifying plant” is set, and its requirement strength is “1” (representing that the requirement is strong, thus cannot be abandoned).

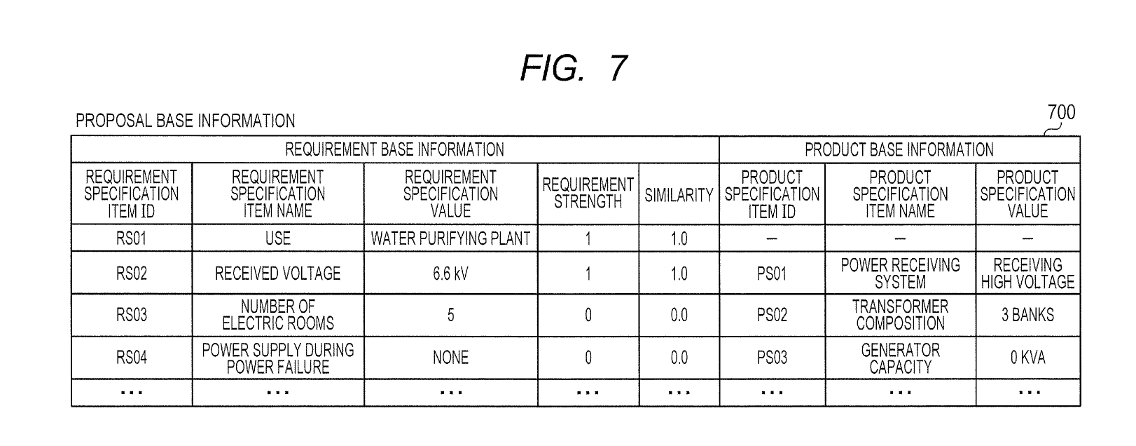

FIG. 7 is a diagram showing a configuration example of proposal base information output by the proposal base selection unit 104 according to the embodiment of the present invention. As illustrated in FIG. 7, proposal base information 700 is information representing an initial draft when proposing product specifications based on the requirement specification original draft, and includes requirement base information and product base information in association with each other. The requirement base information represents requirement specifications under the consideration of the past requirement specifications, for the requirement original draft information. The product base information represents product specifications of a product manufactured in accordance with the requirement base information.

As illustrated in FIG. 7, the requirement base information has requirement specification item IDs, requirement specification item names, requirement specification values, requirement strengths, and similarities, in association with each other. These information items are as described above, and will not repeatedly be described again. The similarity represents the degree of similarity between a requirement specification value included in the requirement specification original draft and a requirement specification value included in the proposal base information.

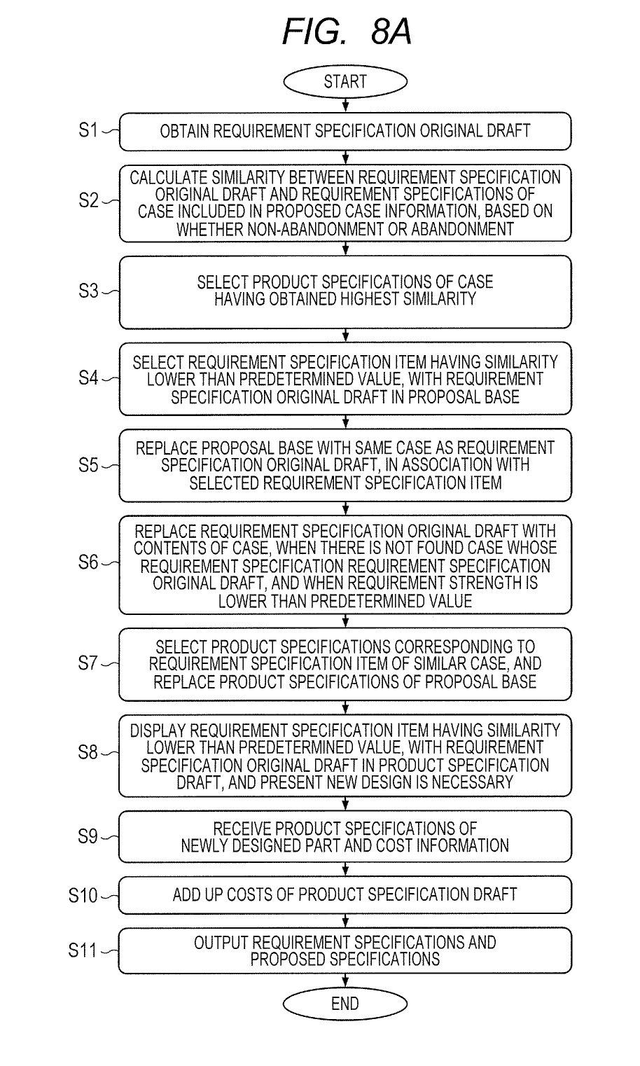

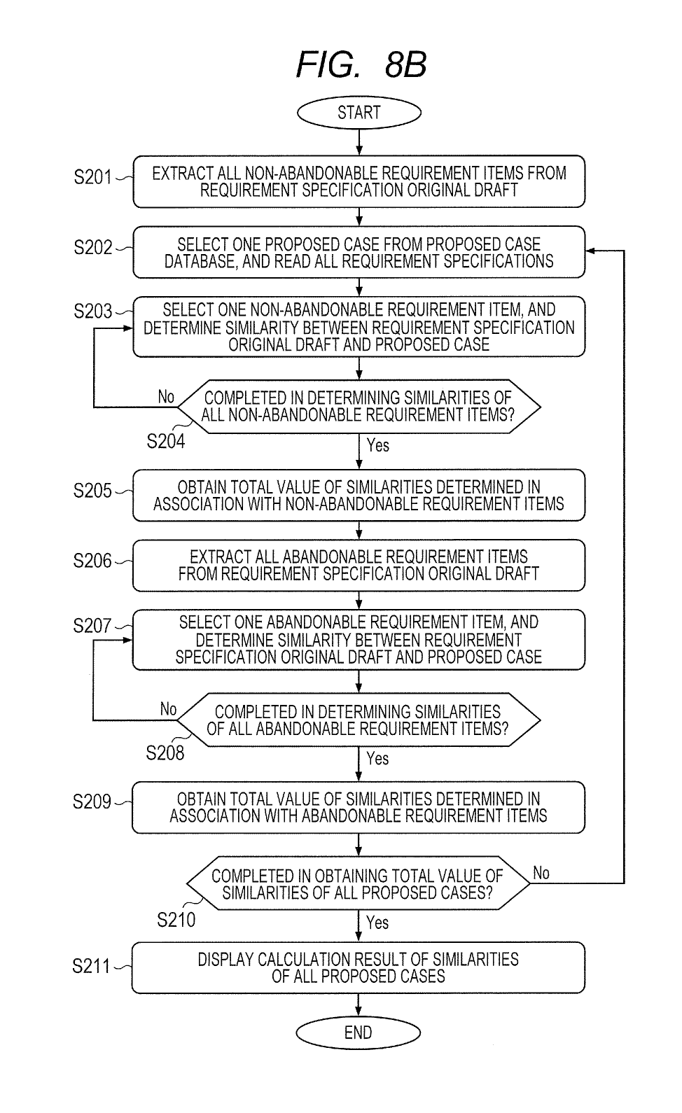

FIG. 8A and FIG. 8B are diagrams each showing a process flow in which the manufacturer prepares a product specification draft and a requirement specification draft using the past achievements, based on a customer-prepared requirement specification original draft, with the proposed specification preparation device 100 according to the embodiment of the present invention. The proposed specification preparation device 100 according to the embodiment of the present invention has a configuration in which a computer including a CPU executes a proposed specification preparation method including following steps S1 to S11.

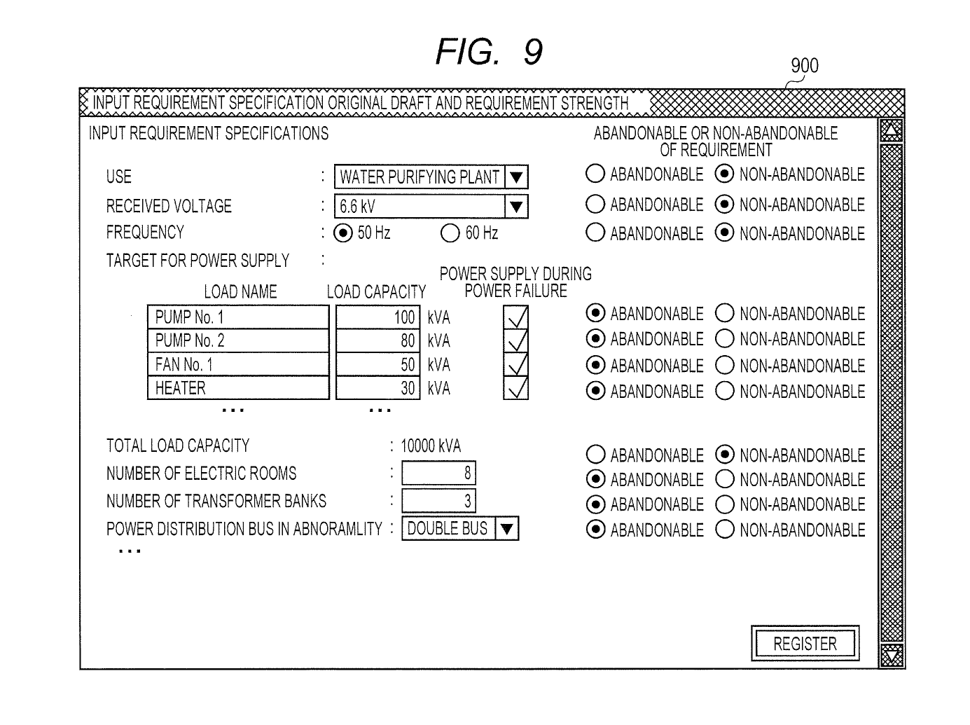

In FIG. 8A, in the proposed specification preparation device 100, the input unit 101 receives the requirement specification original draft (illustrated in FIG. 6) input through a keyboard or a screen (Step S1). For example, the input unit 101 receives and obtains various information included in the requirement specification original draft, from an input screen 900 illustrated in FIG. 9.

In the example of FIG. 9, in the input screen 900, the requirement specifications from the customer include “use” indicating “water purifying plant”, and its requirement specification is non-abandonable (that is, the requirement strength is “1”). Thus input “use” is acquired as one record (record of the requirement specification item “RS01”) (illustrated in FIG. 6), by the input unit 101.

Other items “received voltage”, “number of electric rooms”, and “power supply during power failure” displayed on the input screen 900 are acquired as the requirement specification original draft information illustrated in FIG. 6, by the input unit 101. In the example of FIG. 9, the requirement specification value can be selected or input for each of the requirement specification items, and the requirement strength can be selected from “abandonable” and “non-abandonable”. This requirement strength represents whether the requirement specification value indicates abandonable in association with each requirement specification item. However, the items may be acquired in any other way, for example, by directly setting values.

Back to FIG. 8A, in the proposed specification preparation device 100, the proposal base selection unit 104 calculates the similarity between each item included in the requirement specification original draft input in Step S1 and each item included in the requirement specification table 300 (FIG. 3), of the proposed case information stored in the proposed case database 102, based on whether it is abandonable or non-abandonable (Step S2). This step S2 will more specifically be described using FIG. 8B.

FIG. 8B is a flowchart showing a process procedure of the process (similarity calculation process) of Step S2. As illustrated in FIG. 8B, the proposed base selection unit 104 refers to the requirement specification original draft information 600 acquired by the input unit 101 in Step S1, and extracts any record (record with non-abandonable requirement) whose requirement strength is “1” (Step S201).

The proposal base selection unit 104 reads out the records in the project table 200 (FIG. 2) sequentially from the first record thereof, of the proposed case information stored in the proposed case database 102. The unit 104 acquires the requirement specification ID included in the read record, and extracts any record having the same acquired requirement specification ID from the requirement specification table 300 illustrated in FIG. 3 (Step S202).

The proposal base selection unit 104 compares the records having the same requirement specification item ID, of the record extracted in Step S201 and the record extracted in Step S202, and determines the similarity therebetween (Step S203).

For example, the proposal base selection unit 104 extracts a record whose requirement strength is “1” and requirement specification item ID is “RS01”, of the requirement specification original draft information illustrated in FIG. 6, in Step S201. In Step S202, the proposal base selection unit 104 acquires the requirement specification ID “R01” included in the record with the project ID “PJ01” as the first record, from the project table 200 illustrated in FIG. 2, and extracts records (records having requirement specification item IDs “RS01” to “RS04”, in the example of FIG. 3) with the requirement specification ID “R01” from the requirement specification table 300 illustrated in FIG. 3. In Step S203, the proposal base selection unit 104 compares the requirement specification values of the records having the requirement specification item IDs “RS01”, in the records extracted in these steps. These records have the same value “water purifying plant”. Thus, the similarity of the requirement specification items is “1.0”.

Similarly, when the requirement specification values are not equal, the proposal base selection unit 104 searches for the records including the corresponding requirement specification item ID from the requirement similarity information 500 stored in the similarity definition database 103 of FIG. 5, to find out the record defining the similarity between the two requirement specification values. The proposal base selection unit 104 adopts the similarity of the record, when there is found the record defining the similarity from the requirement similarity information 500. For example, in the example of FIG. 5, in Step S203, when the same requirement specification item ID is “RS04”, the similarity of the requirement specification item is “0.8”.

Further, the proposal base selection unit 104 sets the similarity “0.0” (that is, a new item not prepared in the past), when there is not found any record defining the similarity from the requirement similarity information 500. Accordingly, in step S203, the proposal base selection unit 104 determines how similar the requirement specification item input (as the requirement specification original draft information) is to the previously-requested requirement specification item in the requirement specification table 300.

After this, the proposal base selection unit 104 determines whether the similarities have been set for the entire records (extracted in Step S201) (Step S204). When it is determined that the similarities have been set for the entire records (Step S204; Yes), the unit obtains the total value of the similarities of the requirement specification items (Step S205). When the proposal base selection unit 104 determines that the similarities have not been set for the entire records (Step S204; No), the flow returns to Step S203, and repeats the subsequent procedures. When the procedure of this Step S205 ends, determination is made on the similarities of the requirement specification values of the entire requirement specification items, as non-abandonable requirements, included in the requirement specification original draft information 600.

When the procedures from Step S201 to S205 are completed, like the above procedures, the proposal base selection unit 104 refers to the requirement specification original draft information 600 which has been acquired by the input unit 101 in Step S1, and extracts any record (record corresponding to the abandonable requirement) whose requirement strength is “0” (Step S206).

Of the records extracted in Step S206 and the records extracted from the requirement specification table 300 of FIG. 3 in Step S202, the proposal base selection unit 104 compares the records having the same requirement specification item ID, and determines the similarity therebetween (Step S207).

After this, the proposal base selection unit 104 determines whether the similarities of the entire records extracted in Step S206 have completely been set (Step S208). When it is determined that the similarities have completely been set for the entire records (Step S208; Yes), the unit obtains the total value of the similarities for the requirement specification items (Step S209). When the proposal base selection unit 104 determines that the similarities have not completely been set for the entire records (Step S208; No), the flow returns to Step S207, and repeats the subsequent procedures. When the procedure of this Step S209 ends, determination is made on the similarities of the requirement specification values of the entire requirement specification items, as abandonable requirements, in the requirement specification original draft information 600.

The proposal base selection unit 104 determines whether the procedures from Step S202 to S209 have been performed for the entire proposed case information stored in the proposed case database 102 (Step S210). When the unit determines that the above procedures have not been performed for the entire proposed case information stored in the proposed case database 102 (Step S210; No), the flow returns to Step S202, and repeats the subsequent procedures.

When the proposal base selection unit 104 determines that the procedures from Step S202 to S209 are performed for the entire proposed case information stored in the proposed case database 102 (Step S210; Yes), it displays the calculation result (calculation result of similarities) (Step S211).

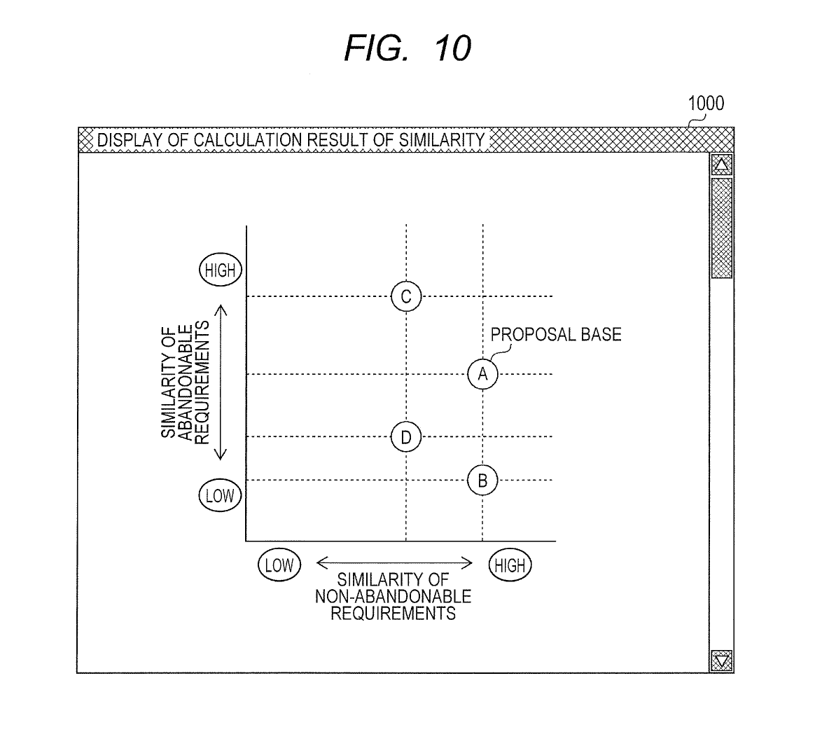

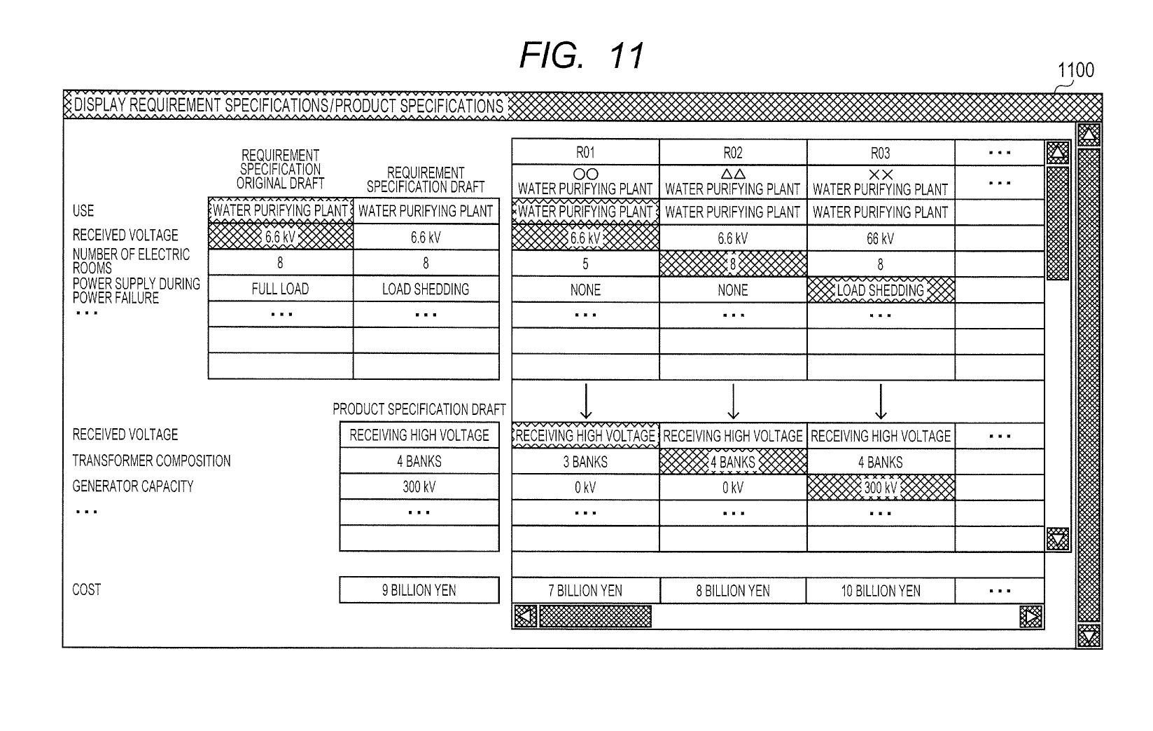

FIG. 10 is a diagram showing an example of a similarity calculation result display screen. As illustrated in FIG. 10, the similarity calculation result display screen is configured to let the customer to check the similarities of the abandonable requirements and the non-abandonable requirements, for the requirement specification IDs in the project table 200 shown in FIG. 2. In the example of FIG. 10, these similarities are displayed, in association with four requirement specifications A to D. Of the requirement specifications A and B having a high similarity of the non-abandonable requirement, it is obvious that the requirement specification A having the higher similarity of the abandonable requirement is selected as proposal base information for proposing to the customer. That is, on the similarity calculation result display screen, of the requirement specifications, selected as proposal base information is the requirement specification having the highest similarity of the non-abandonable requirement and having also the highest similarity of the abandonable requirement. Back to FIG. 8A, descriptions will now be made to the procedures subsequently from Step S3.

The proposal base selection unit 104 selects, as a proposal base, the requirement specification (requirement specification A, in the example of FIG. 10) of a case with the highest similarity obtained in Step S2, and stores the selected proposal base in the requirement base information of the proposal base information 700 illustrated in FIG. 7 (Step S3).

In a specific storing method, as described in FIG. 10, the proposal base selection unit 104 extracts a case having the highest similarity of the requirement strength “1” (that is, the requirement specification having the highest similarity of the non-abandonable requirement). At this time, the proposal base selection unit 104 determines whether there are several corresponding requirement specifications. When it is determined that there is only one requirement specification, the specification is stored in the requirement base information of the proposal base information 700. On the contrary, when it is determined that there are several requirement specifications, the proposal base selection unit 104 stores a case having the highest similarity of the requirement strength “0” (that is, the requirement specification having the highest similarity of the abandonable requirement) in the proposal base information 700. In the example of FIG. 7, the proposal base selection unit 104 selects a project ID “PJ01” (requirement specification ID “R01”) of the project table 200 as a proposal base, and stores the selected project ID in the requirement base information of the proposal base information 700.

In Step S3, if the proposal base selection unit 104 stores the requirement base information in the proposal base information 700, the requirement specification draft preparation unit 105 refers to the requirement base information, and selects a requirement specification item with a lower similarity than a predetermined value (a threshold value) stored in advance in a non-illustrative memory (Step S4). In this embodiment, the unit selects the requirement specification item whose similarity is less than “0.5”. In this case, in the proposal base information of FIG. 7, corresponding records have the requirement specification item names “number of electric rooms” and “power supply during power failure”.

After this, the requirement specification draft preparation unit 105 specifies the record including the requirement specification item selected in Step S4, from the requirement specification original draft information 600 illustrated in FIG. 6, searches for a record including the specified requirement specification item from the requirement specification table 300, and replaces the searched record with the record of the proposal base information 700 (Step S5).

For example, in the example of FIG. 7, in the requirement base information of the proposal base information 700, the selected information is the proposal base whose requirement specification ID is “R01”. Thus, the requirement specification values, corresponding to the requirement specification item names “number of electric rooms” and “power supply during power failure” selected in Step S4, are respectively “5” and “none”. However, in the requirement specification original draft information 600 of FIG. 6, the requirement specification value corresponding to the requirement specification item name “number of electric rooms” is “8”. Thus, the requirement specification draft preparation unit 105 uses the requirement specification item ID “RS03” as a key, to access the requirement specification table 300 of the proposed case information, to specify a record (record “RE01” illustrated in FIG. 3) whose requirement specification value is “8”, and to replace the requirement specification value “5” corresponding to the requirement specification item name “number of electric rooms” illustrated in FIG. 7 with the requirement specification value “8” (FIG. 7 illustrates a state before replacement). This record has a requirement specification ID “R02”, and indicates the case of the project ID “PJ02” as obvious from the project table 200 of FIG. 2. As described above, the record with the requirement specification item ID “RS03” of the proposal base information 700 is replaced with data of the project ID “PJ02”.

The same procedures will be performed for the requirement specification item name “power supply during power failure”. However, in the proposal base information 700 illustrated in FIG. 7, the requirement specification value corresponding to the requirement specification item name “power supply during power failure” is “none”. In the requirement specification original draft information 600 illustrated in FIG. 6, the requirement specification value corresponding to the requirement specification item name “power supply during power failure” is “full load”. In the example of FIG. 3, there is no record whose requirement specification value is “none”. Thus, no replacement is performed in this step.

In Step S5, the requirement specification draft preparation unit 105 replaces a requirement specification value corresponding to the requirement specification item of the requirement specification draft information 600, with the contents of the requirement specification value of the similar record, when there is not found a record whose requirement specification value corresponding to the requirement specification item selected in Step S4 is equal to the requirement specification value of the requirement specification original draft information 600, and when the requirement strength of the requirement specification item is lower than a predetermined value (a threshold value) stored in advance in a non-illustrative memory (step S6).

In this embodiment, when the threshold value is “1” and the requirement strength is lower than “1”, the contents of the requirement specification original draft are replaced. For example, for the requirement specification item “power supply during power failure”, in the requirement specification original draft information 600 in FIG. 6, the requirement specification value is “full load” corresponding to the requirement specification item name “power supply during power failure”, in association with the requirement specification item ID “RS04”. However, in the requirement specification table 300 of the proposed case information, the same case is not found. That is, the replacement has not been performed in Step S5 as described above. The requirement specification draft preparation unit 105 uses the requirement specification item ID “RS04” corresponding to the requirement specification item “power supply during power failure” as a key. With the key, the unit accesses the requirement specification original draft information 600, and refers to the “requirement strength” corresponding to the requirement specification item name “power supply during power failure” in association with the requirement specification item ID “RS04”, and determines whether the value is “0”. When the referred value is “0”, the requirement specification value “none” corresponding to the requirement specification item name “power supply during power failure” is replaced with the similar requirement specification value.

Specifically, the requirement specification draft preparation unit 105 uses the requirement specification item ID “RS04” as a key, to access the requirement specification table 300 with the proposed case information using the key. The requirement specification table 300 illustrated in FIG. 3 includes records (records “RE021” and “RE022” illustrated in FIG. 3) corresponding to the requirement specification item ID “RS04”, in association with the requirement specification IDs “R01” and “R02”. With reference to the requirement similarity information 500 of the similarity definition database 103 illustrated in FIG. 5, the requirement specification values (“full load” and “load shedding” corresponding to the requirement specification item name “power supply during power failure”) are set to a similarity “0.8”. Thus, the requirement specification draft preparation unit 105 selects a record (record “RE023” illustrated in FIG. 3) corresponding to the requirement specification ID “R03” and the requirement specification item “RS04” in the requirement specification table 300, and replaces the requirement specification value “none” corresponding to the requirement specification item “power supply during power failure”, with “load shedding”, and replaces the similarity “0.0” with “0.8” (FIG. 7 shows a state before replacement).

This record has a requirement specification ID “R03”, and indicates the case of the project ID “PJ03” as obvious from the project table 200 illustrated in FIG. 2. As described above, the record with the requirement specification item ID “RS04” in the proposal base information 700 is replaced with data of the project ID “PJ03”. Accordingly, even when there is no particular requirement from the customer in the past, some similar specification achieved in the past can be proposed. In the above-described example, the reason why the threshold value of the requirement strength is less than “1” is that the first priority is the customer request. Back to FIG. 8A, descriptions will now be made to the procedures subsequently from Step S7.

Based on the result of Step S6, the product specification draft preparation unit 106 replaces a product specification value in the product base information of the proposal base information 700. For example, in Step S6, the requirement specification draft preparation unit 105 replaces the requirement specification value corresponding to the requirement specification item ID “RS04”, with a requirement specification value of the requirement specification item corresponding to the requirement specification ID “R03”. Thus, the product specification draft preparation unit 106 refers to the project table 200 illustrated in FIG. 2, specifies a project ID “PJ03” corresponding to the requirement specification ID “R03”, and acquires a product specification ID “P03” corresponding to the project ID. Then, the product specification draft preparation unit 106 refers to the product specification table 400 illustrated in FIG. 4, specifies a record (record “RE03” illustrated in FIG. 4) which satisfies the product specification ID “P03” and the product specification item “PS03” corresponding to the requirement specification item “RS04” replaced in FIG. 7, and acquires a product specification value “300 kVA” of the record. The product specification draft preparation unit 106 replaces the product specification value “0 kVA” of the product base information (FIG. 7) with “300 kVA” (FIG. 7 illustrates a state before replacement).

After execution of Step S7, the product specification draft preparation unit 106 refers to the similarities in the proposal base information 700, extracts a requirement specification item with a value lower than a predetermined value, and causes the output unit 108 to display the item as the contents to be newly designed (Step S8). In this embodiment, the product specification draft preparation unit 106 outputs the record with the similarity “0” as a record to be newly designed. For example, in the example of FIG. 7, “number of electric rooms” whose requirement specification item ID is “RS03” has a similarity “0.0”. Thus, the product specification draft preparation unit 106 determines that the item needs to be newly designed, and outputs information representing the necessity.

The input unit 101 receives the newly designing result, stores the received result as a product specification value of the proposal base information 700, and supplies cost information to the product specification draft evaluation unit 107 (Step S9). For example, for the requirement specification item “number of electric rooms” to be newly designed, when this item is designed in accordance with a customer required specification, “number of electric rooms” is set to “8” based on the requirement specification original information 600 illustrated in FIG. 6, and the input is received. The product specification draft evaluation unit 107 refers to a product specification value included in the product base information of the proposal base information 700, and acquires the cost from the product specification table 400 having the proposed case information, using the referred product specification value as a key. In this case, for a new designing part, the input screen illustrated in FIG. 9 includes a cost input box corresponding to the requirement specification item “number of electric rooms”, to acquire the input value as the cost.

After this, the product specification draft evaluation unit 107 adds up the costs in the entire records of the proposal base information 700 (Step S10). The output unit 108 outputs the requirement specifications and the product specifications, with reference to the proposal base information 700 (Step S11).

FIG. 11 is a diagram showing an example of the requirement specifications and product specifications output by the product specification draft evaluation unit 107 onto a screen. As illustrated in FIG. 11, the product specification draft evaluation unit 107 displays, on the screen, the requirement specification original draft information illustrated in FIG. 6, requirement base information (requirement specification draft information after replacing the requirement specification value) illustrated in FIG. 7, and the product specification draft including the cost with the product base information illustrated in FIG. 7, in association with the past case information (the requirement specification table 300 illustrated in FIG. 3 and the product specification table 400 illustrated in FIG. 4). On this screen, those items highlighted in the requirement specification original draft have the requirement strength “1”. The value highlighted in the past case information represents that it has been adopted in the requirement specification draft and the product specification draft.

In this embodiment, the proposed specification preparation device 100 includes the input unit 101, the case database 102, the proposal base selection unit 104, the requirement specification draft preparation unit 105, the product specification draft preparation unit 106, and the output unit 108. Specifically, the input unit 101 receives an input of the requirement specification draft, which includes the requirement specifications from the customer and the requirement strength information representing whether the requirement specification is abandonable or non-abandonable, in association with each other. The case database 102 stores the requirement specifications proposed based on the past requirement specifications and the product specifications prepared in accordance with the proposed requirement specifications. The proposal base selection unit 104 selects a proposal base as the main point of newly proposed requirement specifications, from the proposed requirement specifications stored in the case database, based on the requirement specifications and the requirement strength included in the requirement specification original draft received by the input unit. The requirement specification draft preparation unit 105 compares the requirement specifications included in the proposal base with the requirement specifications included in the requirement specification original draft, and changes the requirement specifications included in the proposal base into the requirement specifications included in the requirement specification original draft or into the requirement specifications similar to the requirement specifications included in the requirement specification original draft, of the requirement specifications stored in the case database, when the requirement specifications included in the proposal base do not satisfy the customer requirement. The product specification draft preparation unit 106 prepares the product specifications in accordance with the requirement specifications prepared by the requirement specification draft preparation unit. The output unit 108 outputs the proposed specification form including the requirement specification draft and the product specification draft. Accordingly, the proposal base is selected from the proposed case information in consideration of the requirement strength of each item of the requirement specification information. For different parts between the proposal base and the requirement specification original draft, the requirement specification original draft is changed while preparing the product specification draft based on the requirement strength and the proposed case information. Therefore, the manufacturer can select the product specifications with the past achievements, in a preferential manner, and can prepare the product specification draft and the requirement specification draft so as to achieve the customer satisfactions.

The device further includes the product specification evaluation unit 107 which evaluates at least one of the product functions, performance, cost, and due dates, based on the product specification draft prepared by the product specification draft preparation unit 106. Thus, the device provides information for comparing a plurality of product specification drafts. As a result, the manufacturer and the customer can compare and study the plurality of product specification drafts, while understanding their advantages and disadvantages.

Further, the proposal base selection unit 104 calculates the similarity between the requirement specification stored in the case database 102 and each of the requirement specifications whose requirement strength information respectively indicate non-abandonable requirement specification and abandonable specification. The unit 104 sets the requirement specification with a high similarity to the requirement specification whose requirement specification is non-abandonable, as a proposal base. Thus, the unit selects the proposal base with the customer non-abandonable requirement specification in a preferential manner. When the requirement specification stored in the case database 102 has the equal similarity to the requirement specification whose requirement strength information indicates the non-abandonable specification, the proposal base selection unit 104 sets the requirement specification having a high similarity to the abandonable requirement specification as a proposal base. Thus, the manufacturer can select a proposal base which does not have many changes to be made at the stage of preparing the product specification draft.

The product specification preparation unit 106 replaces the proposal base with the product specification corresponding to the abandonable requirement specification with a high similarity. When there is no case corresponding to the same requirement, the proposal base is replaced with the product specification of a case corresponding to a similar abandonable requirement. Therefore, the manufacturer can prepare the product specification draft that can be accepted by the customer.

Further, the similar definition database 103 stores a similarity between one requirement specification and another requirement specification in association with each other. When the case database 102 does not store a particular satisfactory requirement specification as an abandonable requirement specification having requirement strength and corresponding to the requirement specification included in the requirement specification original draft, the requirement specification draft preparation unit 105 replaces the requirement specification with a requirement specification with a high similarity to the requirement specification stored in the similarity definition database 103. Therefore, the manufacturer can present the requirement specification draft which can be accepted by the customer as an alternative draft of the requirement specification original draft prepared by the customer.

The proposed specification preparation method according to the present invention is realized by a computer program controlling a computer to execute the above steps in the embodiment. The present invention is not limited to the above-described embodiment. The constituent elements may be modified and embodied at the execution phase without departing from the scope and spirit of the invention. Various inventions may be formed in appropriate combination with a plurality of constituent elements disclosed in the above-described embodiment. For example, some constituent elements may be omitted from the entire constituent elements disclosed in the above-described embodiment. Further, the constituent elements may be formed in combinations of different embodiments.

### EXPLANATION OF REFERENCES

100 proposed specification preparation device
101 input unit
102 case database
103 similarity definition database
104 proposal base selection unit
105 requirement specification draft preparation unit
106 product specification draft preparation unit
107 product specification draft evaluation unit
108 output unit
109 control unit
200 project table
300 requirement specification table
400 product specification table
500 requirement similarity information
600 requirement specification original draft information
700 proposal base information
900 input screen
1000 result output screen
1100 specification output screen

What is claimed is:

1. A proposed specification preparation device comprising:
an input unit which receives an input of a requirement specification original draft, including a requirement specification from a customer and requirement strength information representing whether the requirement specification is abandonable, in association with each other;
a case database which stores requirement specifications proposed based on the requirement specification in the past and a product specification prepared in accordance with the proposed requirement specification;
a proposal base selection unit which selects a proposal base as a main point of a requirement specification to be newly proposed, from the proposed requirement specifications stored in the case database, based on the requirement specification and the requirement strength included in the requirement specification original draft received by the input unit;
a requirement specification draft preparation unit which compares the requirement specification included in the proposal base with the requirement specification included in the requirement specification original draft, and when the requirement specification included in the proposal base does not satisfy a requirement of the customer, changes the requirement specification included in the proposal base into the requirement specification included in the requirement specification original draft or the requirement specification similar to the requirement specification included in the requirement specification original draft within the requirement specifications stored in the case database;
a product specification draft preparation unit which prepares the product specification in accordance with the requirement specification prepared by the requirement specification draft preparation unit; and
an output unit which outputs a proposed specification form including the requirement specification draft and the product specification draft.

2. The proposed specification preparation device according to claim 1, further comprising:
a product specification evaluation unit which evaluates at least one of a function, performance, cost, and a due date of the product, based on the product specification draft prepared by the product specification draft preparation unit.

3. The proposed specification preparation device according to claim 1,
wherein the proposal base selection unit calculates a similarity between the requirement specification stored in the case database and each of the requirement specification whose requirement strength information indicates non-abandonable requirement specification and the requirement specification whose requirement strength information indicates abandonable requirement specification, and sets a requirement specification with a high similarity to the requirement specification whose requirement specification is non-abandonable, as the proposal base.

4. The proposed specification preparation device according to claim 3,
wherein the proposal base selection unit sets a requirement specification with a high similarity to the abandonable requirement specification, as the proposal base, when the requirement specification stored in the case database has an equal similarity to the requirement specification whose requirement strength information indicates non-abandonable.

5. The proposed specification preparation device according to claim 3,
wherein the product specification preparation unit replaces the proposal base with the product specification corresponding to the abandonable requirement specification with the high similarity.

6. The proposed specification preparation device according to claim 1, further comprising:
a similarity definition database which stores a similarity between one requirement specification and another requirement specification,
wherein the requirement specification draft preparation unit replaces the requirement specification with a requirement specification having a high similarity to the requirement specification stored in the similarity definition database, when there is no satisfactory requirement specification in the requirement specifications stored in the case database, as a requirement specification whose requirement strength indicates abandonable and corresponding to the requirement strength included in the requirement specification original draft.

7. A proposed specification preparation method comprising:
an input-receiving step of receiving an input of a requirement specification original draft including a requirement specification from a customer and requirement strength information indicating whether the requirement specification is abandonable, in association with each other;
a proposal base selecting step of selecting a proposal base as a main point of a newly-proposed requirement specification, from the proposed requirement specifications stored in the case database which stores a requirement specification proposed in the past based on the requirement specification and a product specification prepared in accordance with the proposed requirement specification, based on the requirement specification and the requirement strength included in the requirement specification original draft received in the input-receiving step;
a requirement specification draft preparing step of comparing the requirement specification included in the proposal base with the requirement specification included in the requirement specification original draft, and changing the requirement specification included in the proposal base into the requirement specification included in the requirement specification original draft or a requirement specification similar to the requirement specification included in the requirement specification original draft within the requirement specifications stored in the case database, when the requirement specification included in the proposal base does not satisfy the customer;
a product specification draft preparing step of preparing the product specification in accordance with the requirement specification prepared in the requirement specification draft preparing step; and
an outputting step of outputting a proposed specification form including the requirement specification draft and the product specification draft.

8. The proposed specification preparation method according to claim 7, further comprising:
a product specification evaluation step of evaluating at least one of a function, performance, cost, and a due date of a product, based on the product specification draft prepared in the product specification draft preparing step.

9. The proposed specification preparation method according to claim 7,
wherein the proposal base selecting step includes a step of calculating a similarity between the requirement specification stored in the case database and a requirement specification whose requirement strength information indicates non-abandonable and the requirement specification whose requirement strength information is abandonable, and includes also a step of setting a requirement specification having a high similarity to the requirement specification whose requirement strength information indicates non-abandonable, as the proposal base.

10. The proposed specification preparation method according to claim 9,
wherein the proposal base selection step includes a step of setting a requirement specification having a high similarity to the abandonable requirement specification, as the proposal base, when the requirement specification stored in the case database has an equal similarity to the requirement specification whose requirement strength information indicates non-abandonable.

11. The proposed specification preparation method according to claim 9,
wherein the product specification preparing step includes a step of replacing the proposal base with the product specification corresponding to the abandonable requirement specification with the high similarity.

12. The proposed specification preparation method according to claim 7,
wherein the requirement specification draft preparing step includes a step of replacing the requirement specification with a requirement specification having a high similarity to the requirement specification stored in the similarity definition database which stores a similarity between one requirement specification and another requirement specification, as a requirement specification whose requirement strength indicates abandonable and corresponding to the requirement specification included in the requirement specification original draft, when there is no satisfactory requirement specification in the requirement specifications stored in the case database.
